(19) United States
(12) Patent Application Publication
(10) Pub. No.: US 2015/0350247 A1
(43) Pub. Date: Dec. 3, 2015

(54) EFFICIENT SECURE INSTANT MESSAGING

(71) Applicant: Apple Inc., Cupertino, CA (US)

(72) Inventors: Mitchell D. Adler, Cupertino, CA (US); Michael L.H. Brouwer, San Jose, CA (US); Conrad Sauerwald, Mountain View, CA (US)

(21) Appl. No.: 14/477,564

(22) Filed: Sep. 4, 2014

Related U.S. Application Data
(60) Provisional application No. 62/005,794, filed on May 30, 2014.

(51) Int. Cl. H04L 29/06; H04L 12/58

(52) U.S. Cl. CPC H04L 63/166; H04L 51/04; H04L 63/061; H04L 63/18

(57) ABSTRACT

A method and apparatus of a device that enables a user to participate in a secure instant messaging session by starting with a low security connection before switching to a high security connection is described. The device concurrently establishes a low security connection and a high security connection with a remote participant of the secure instant messaging session. The device sends a first message to the remote participant through the low security connection while the high security connection is being established. The device further determines whether the high security connection is established. If the high security connection is established, the device can send a second message to the remote participant through the high security connection. If the high security connection is not yet established, the device can send the second message to the remote participant through the low security connection.

### RELATED MATTERS

This application claims the benefit of the earlier filing date of provisional application No. 62/005,794, filed May 30, 2014, entitled “Efficient Secure Instant Messaging”.

### FIELD OF THE DISCLOSURE

This disclosure relates generally to digital data communications and more particularly to devices for electronic messaging.

### BACKGROUND

Instant messaging is a type of online chat which offers real-time text and/or multimedia object transmission between two or more participants over the Internet or other type of network. As a wide variety of instant messaging tools become ever more popular, they are entrusted with all forms of information, including very sensitive data. As a result, the need to secure instant messaging services has received plenty of attention.

While many of the popular instant messaging solutions do not provide any means of protection, others have already started adding security functionality. Some instant messaging tools provide a low level of security, e.g. by encrypting and decrypting the contents of the messages such that only the actual users can understand them, or by authenticating the identity of the sender of the messages. Some instant messaging tools provide a high level of security by using cryptographic protocols such as Off-the-Record Messaging (OTR) and Transport Layer Security (TLS). Therefore, in addition to authentication and encryption, these instant messaging tools may provide security functionality such as perfect forward secrecy and malleable encryption.

Perfect forward secrecy means messages are only encrypted with temporary per-message AES keys negotiated using the Diffie-Hellman key exchange protocol. The compromise of any long-lived cryptographic keys does not compromise any previous conversations, even if an attacker is in possession of encrypted information of the previous conversations. Malleable encryption gives the participants plausible deniability of their conversations, which means that an adversary will not be able to prove that the participants had a conversation or said anything in particular.

The primary motivation behind the high level security for instant messaging tools was providing deniability for conversation participants while keeping conversations confidential, like a private conversation in real life, or off-the-record conversations in journalism sourcing. This is in contrast with instant messaging tools with low level security that produce output which can be later used as a verifiable record of the communication event and the identities of the participants.

### SUMMARY OF THE DESCRIPTION

A method and apparatus of a device that enables a user to participate in a secure instant messaging session by starting with a low security connection before switching to a high security connection is described. In an exemplary embodiment, the device concurrently establishes a low security connection and a high security connection with a remote participant of the secure instant messaging session. The device sends a first message to the remote participant of the secure instant messaging session through the low security connection while the high security connection is being established. The device determines whether the high security connection is established. If the high security connection is established, the device can send a second message to the remote participant through the high security connection. If the high security connection is not yet established, the device can send the second message to the remote participant through the low security connection.

In one embodiment, the device receives requests from a remote participant of the secure instant messaging session to establish a high security connection and a low security connection. The device concurrently establishes the high security connection and the low security connection with the remote participant. The device can receive a first message from the remote participant through the low security connection while the high security connection is being established. The device determines whether the high security connection is established. If the high security connection is established, the device can send a second message to the remote participant through the high security connection. If the high security connection is not yet established, the device can send the second message to the remote participant through the low security connection.

In one embodiment, the low security connection uses a cryptographic protocol that does not provide perfect forward secrecy or malleable encryption. In one embodiment, the high security connection uses a cryptographic protocol that provides at least one of perfect forward secrecy or malleable encryption. In one embodiment, the high security connection uses Off-the-Record Messaging (OTR) protocol or Transport Layer Security (TLS) protocol. In one embodiment, the first and second messages are received from a local participant of the secure instant messaging session.

A method and apparatus of a device that enables a user to participate in a secure instant messaging session by simultaneously negotiating several different types of secure instant messaging channels is described. In one embodiment, the device concurrently establishes several secure instant messaging channels with a remote participant of the secure instant messaging session. Each secure instant messaging channel provides a different set of functionalities. The device can select one of the channels based on a set of criteria. The device then sends a message to the remote participant through the selected channel.

In one embodiment, the set of criteria includes whether a channel has been established. In one embodiment, the set of criteria includes whether the set of functionalities of a channel provides the highest security. In one embodiment, the set of criteria includes whether the set of functionalities of a channel includes one or more security related functionalities. In one embodiment, the set of criteria includes whether the set of functionalities of a channel includes one or more non-security related functionalities.

Other methods and apparatuses are also described. Non-transitory machine readable storage media containing executable computer program which when executed cause a data processing system to perform one or more of the methods of this disclosure are also described.

### BRIEF DESCRIPTION OF THE DRAWINGS

The disclosure is illustrated by way of example and not limitation in the figures of the accompanying drawings in which like references indicate similar elements.

FIG. 1 is a diagram illustrating the steps of one embodiment for two users to efficiently participate a secure instant messaging session.

FIG. 2 illustrates a flowchart of one embodiment of a process to participate a secure instant messaging session by an initiating user on a device.

FIG. 3 illustrates a flowchart of one embodiment of a process to participate a secure instant messaging session by a target user on a device.

FIG. 4 illustrates a detailed diagram of a device of one embodiment that participates in a secure instant messaging session.

FIG. 5 illustrates a flowchart of one embodiment of a process to participate in a secure instant messaging session by simultaneously negotiating several different types of secure instant messaging channels on a device.

FIG. 6 shows one example of a data processing system, which may be used with one embodiment.

FIG. 7 shows an example of another data processing system which may be used with one embodiment.

### DETAILED DESCRIPTION

A method and apparatus of a device that enables a user to efficiently participate in a secure instant messaging session is described. In the following description, numerous specific details are set forth to provide thorough explanation of embodiments of the disclosure. It will be apparent, however, to one skilled in the art, that embodiments of the disclosure may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the disclosure. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose device or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that enables a user to efficiently participate in a secure instant messaging session by starting with a low security connection before switching to a high security connection is described. In one embodiment, the device initially uses a low security connection to send or receive messages while a high security connection is being established. Once the high security connection is established, the device stops using the low security connection and starts using the high security connection to send or receive messages. This can avoid potential delays in sending or receiving messages that may be caused by waiting to send and receive messages until the high security connection has been established, and provide a high level of security for the instant messaging session once the high security connection is established.

When user Alice tries to have a high security instant messaging conversation with user Bob, she first needs establish a high security connection (e.g., a connection that uses OTR protocol or TLS protocol) before she can send out her first message to Bob. For example, in the case of using OTR protocol for the high security connection, it takes two and a half round trips before Alice can actually send her first message across the high security connection to Bob. If both Alice and Bob are online during the initialization of the high security instant messaging session, the two and a half round trips are not a big concern. However, in an extreme scenario, Alice and Bob live on opposite sides of the world, e.g. Alice is in Tokyo and Bob is in New York. Thus Bob is always offline when Alice is online, and vice versa. As a result, the two and a half round trips could take two and a half days to complete, which is unacceptable for most users of instant messaging services.

In one embodiment, Alice and Bob can send messages to each other through a low security connection while trying to establish a high security connection. Only after the high security connection has been established, i.e. the negotiation for establishing the high security connection has been completed, Alice and Bob switch to the high security connection to send messages to each other. In one embodiment, a high security connection uses cryptographic protocols (e.g., OTR and TLS) that provide high level security functionality such as perfect forward secrecy or malleable encryption. In one embodiment, a low security connection uses cryptographic protocols that provide authentication and/or encryption, but those cryptographic protocols do not provide high level security functionality such as perfect forward secrecy or malleable encryption. A low security connection can be established instantly, without going through multiple round trips of handshaking. Therefore, by using a low security connection while establishing a high security connection simultaneously, Alice and Bob can start chatting immediately.

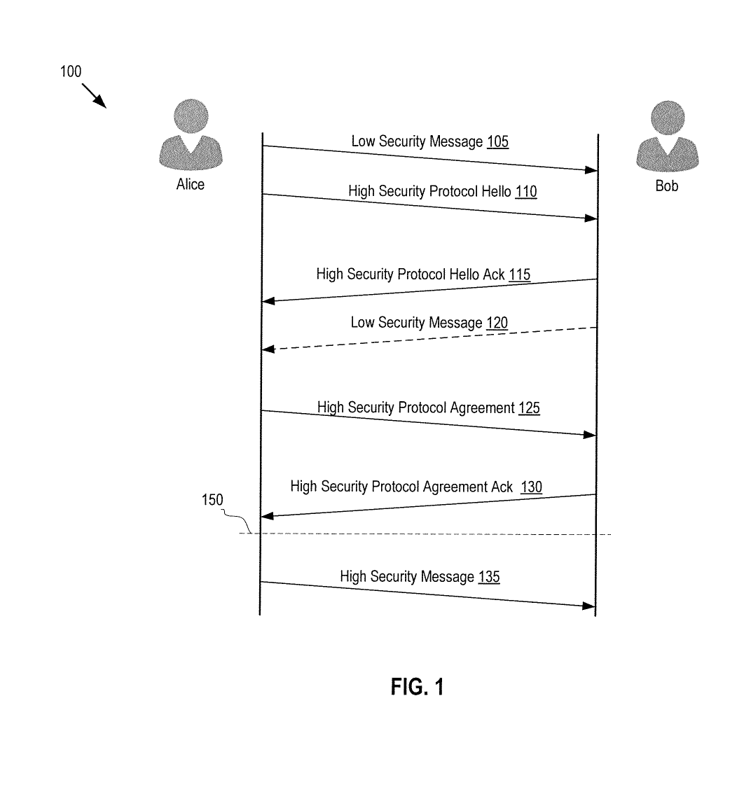

FIG. 1 is a diagram 100 illustrating the steps of one embodiment for two users to efficiently participate in a secure instant messaging session. Specifically, this figure shows users Alice and Bob participate in the secure instant messaging session by starting with a low security connection before switching to a high security connection. In one embodiment, the devices used by Alice and Bob can be desktop computers, servers, smartphones, laptops, personal digital assistants, music playing devices, gaming devices, or any other devices that can execute instant messaging programs.

As illustrated in FIG. 1, Alice initiates the secure instant messaging session by sending a low security message 105 to Bob while concurrently sending a high security protocol hello 110 to Bob. The low security message 105 is the first conversation message of the instant messaging session. In one embodiment, the low security message 105 is encrypted using Bob's public encryption key and signed using Alice's private signing key for authentication. The high security protocol hello 110 is the first handshake message of the instant messaging session needed to establish a high security connection between Alice and Bob. In one embodiment, the high security protocol hello 110 can be a way to ensure which protocol version is going to be used by the high security connection. For example, the high security protocol hello 110 can be a request to initiate OTR v2 or OTR v3.

After receiving the high security protocol hello 110, Bob sends a high security protocol hello acknowledgement 115 back to Alice. In one embodiment, the high security protocol hello acknowledgement 115 agrees to the protocol version to be used by the high security connection. Bob can also optionally start sending low security messages, e.g. low security message 120, back to Alice. In one embodiment, the low security message 120 is encrypted using Alice's public encryption key and signed using Bob's private signing key for authentication.

After receiving the high security protocol hello acknowledgement 115, Alice sends a high security protocol agreement 125 to Bob. Alice can also optionally send other low security messages to Bob. In response to the high security protocol agreement 125, Bob sends a high security protocol agreement acknowledgement 130 back to Alice. In one embodiment, the high security protocol agreement 125 and the high security protocol agreement acknowledgement 130 perform Diffie-Hellman key exchange. Once Alice successfully receives the high security protocol agreement acknowledgement 130, the high security connection for the instant messaging session between Alice and Bob has been established, as indicated by line 150.

Once the high security connection is established, Alice can start sending high security messages, e.g. high security message 135, to Bob using the high security connection, and Bob can also start sending high security messages back to Alice using the high security connection. By switching between the low security connection and the high security connection, the disclosure combines the usability of the low security connection and the better security properties of the high security connection to form a more efficient secure instant messaging session.

One of ordinary skill in the art will recognize that diagram 100 is a conceptual representation of the steps used to establish a more efficient instant messaging session. The specific steps of diagram 100 may not be conducted in the exact order or exact number shown and described. For example, the number of round trips for establishing the high security connection may be different for different cryptographic protocols that provide high level security functionalities.

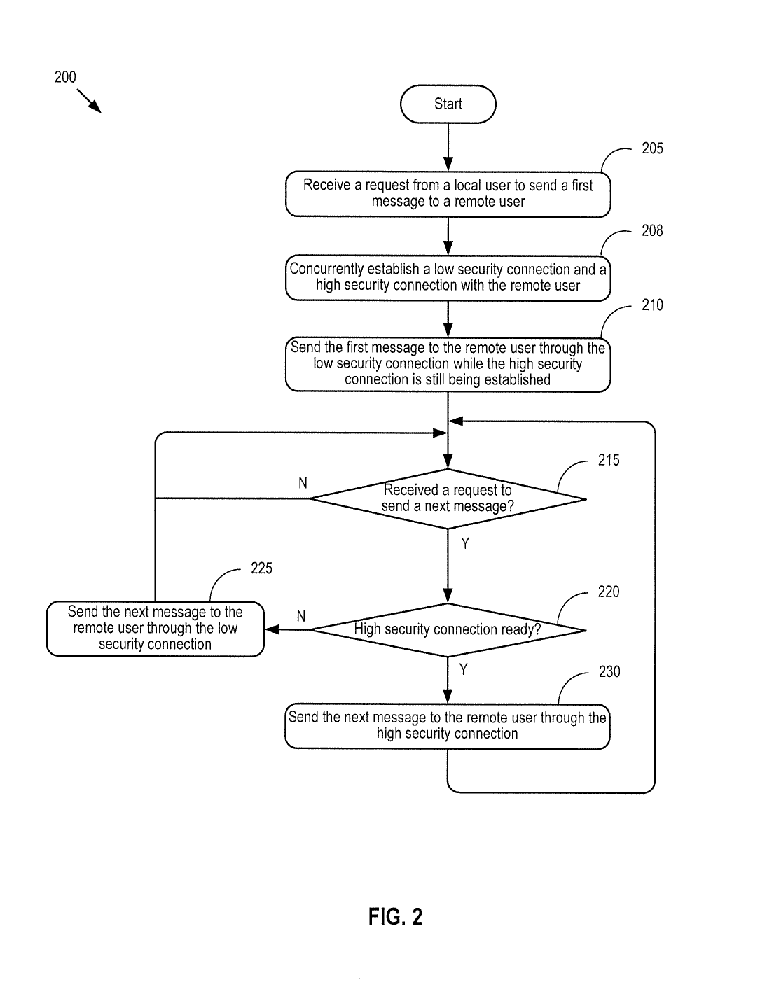

FIG. 2 illustrates a flowchart of one embodiment of a process 200 to participate in a secure instant messaging session by an initiating user on a device. In one embodiment, a high security connection uses cryptographic protocols (e.g., OTR and TLS) that provide high level security functionality such as perfect forward secrecy or malleable encryption. In one embodiment, a low security connection uses cryptographic protocols that provide authentication and/or encryption, but those cryptographic protocols do not provide high level security functionality such as perfect forward secrecy or malleable encryption. In one embodiment, process 200 is invoked when Alice tries to start a secure instant messaging conversation with Bob as described in relation to FIG. 1 above, or when an old session between them has expired and a new session needs to be initiated.

Process 200 begins by receiving (at block 205) a request from a local user to send a first message to a remote user. In one embodiment, the local user is Alice and the remote user is Bob, as described in FIG. 1 above. At block 208, process 200 concurrently establishes a low security connection and a high security connection with the remote user. In one embodiment, even though process 200 starts to establish the low security connection and the high security connection at the same time, the low security connection is established first.

Once the low security connection is established, process 200 sends (at block 210) the first message to the remote user through the low security connection while the high security connection is still being established. In one embodiment, the first message is sent as the low security message 105, as described in FIG. 1 above. In one embodiment, process 200 starts to establish the high security connection with the remote user by sending the high security protocol hello 110, as described in FIG. 1 above.

At block 215, process 200 determines whether a request to send a next message to the remote user has been received from the local user. If a request to send a new message has not been received, process 200 loops back to block 215 to check again. If a request to send a next message has been received from the local user, process 200 determines (at block 220) whether the high security connection is ready, meaning the cryptographic protocol (e.g., OTR or TLS) has finished all the handshaking and a high security instant messaging session based on the cryptographic protocol has been established. In one embodiment, the high security connection is ready when line 150 described in FIG. 1 above has been reached.

If the high security connection is ready, process 200 sends (at block 230) the next message to the remote user through the high security connection. In one embodiment, the next message sent at block 230 is the high security message 135 described in FIG. 1 above. Process 200 then loops back to block 215 to check if a new message request has been received from the local user.

If the high security connection is not ready yet, process 200 sends (at block 225) the next message to the remote user through the low security connection. Process 200 then loops back to block 215 to check if a new message request has been received from the local user. Process 200 is terminated when the secure instant messaging session is terminated (e.g., by user) or expired (e.g., a certain time limit has passed without user activity or network connection).

One of ordinary skill in the art will recognize that process 200 is a conceptual representation of the operations used to participate in a secure instant messaging session. The specific operations of process 200 may not be performed in the exact order shown and described. The specific operations may not be performed in one continuous series of operations, and different specific operations may be performed in different embodiments. Furthermore, process 200 could be implemented using several sub-processes, or as part of a larger macro process. One of ordinary skill in the art will also recognize that a local user and a remote user are two users who use two different devices, and can be physically near each other.

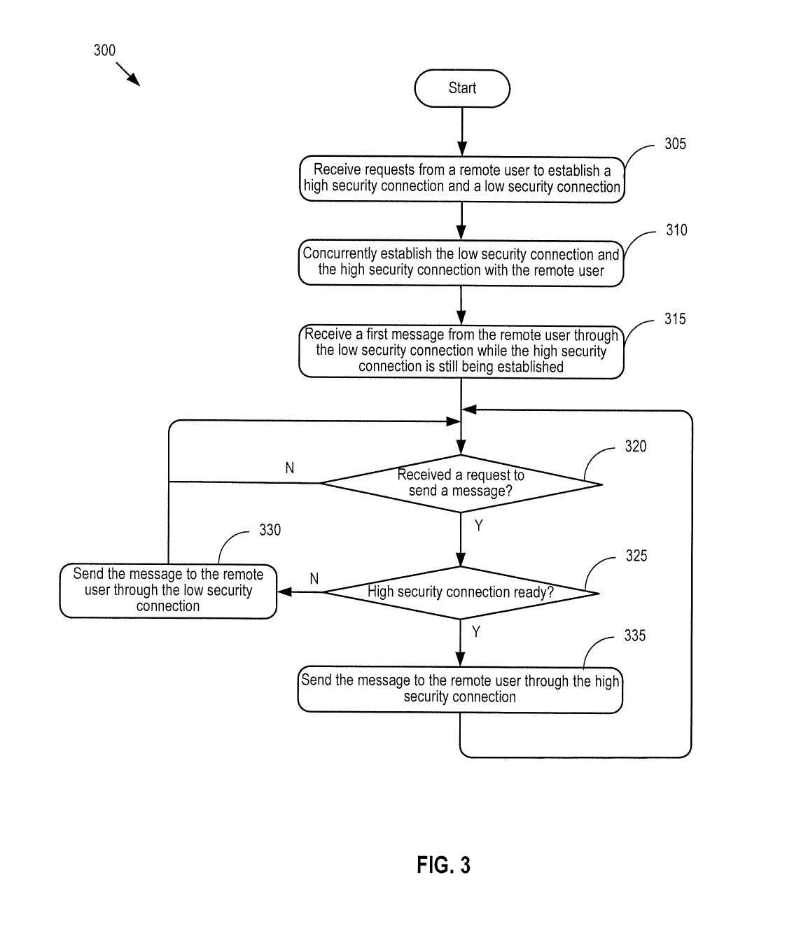

FIG. 3 illustrates a flowchart of one embodiment of a process 300 to enable a target user to participate in a secure instant messaging session on a device. In one embodiment, a high security connection uses cryptographic protocols (e.g., OTR and TLS) that provide high level security functionality such as perfect forward secrecy or malleable encryption. In one embodiment, a low security connection uses cryptographic protocols that provide authentication and/or encryption, but those cryptographic protocols do not provide high level security functionality such as perfect forward secrecy or malleable encryption. In one embodiment, process 300 is invoked when Bob receives a secure instant messaging conversation from Alice as described in relation to FIG. 1 above, or when an old session between them has expired and Alice is trying to initiate a new session.

Process 300 begins by receiving (at block 305) requests from a remote user to establish a high security connection and a low security connection with the local user. In one embodiment, the local user is Bob and the remote user is Alice, as described in relation to FIG. 1 above. In one embodiment, the requests from the remote user are in the form of high security protocol hello 110 and low security message 105, as described in relation to FIG. 1 above.

At block 310, process 300 concurrently establishes the high security connection and the low security connection with the remote user. In one embodiment, process 300 establishes the high security connection by sending the high security protocol hello acknowledgment 115 and the high security protocol agreement acknowledgement 130, and receiving the high security protocol agreement 125, as described in relation to FIG. 1 above. In one embodiment, even though process 300 starts to establish the high security connection and the low security connection at the same time, the low security connection is established first.

Once the low security connection is established, process 300 receives (at block 315) a first message from the remote user through the low security connection while the high security connection is still being established. In one embodiment, the low security connection is established instantly and the first message is received as the low security message 105, as described in relation to FIG. 1 above.

At block 320, process 300 determines whether a request to send a message to the remote user has been received from the local user. If a request to send a new message has not been received, process 300 loops back to block 320 to check again. If a request to send a new message has been received from the local user, process 300 determines (at block 325) whether the high security connection is ready, meaning the cryptographic protocol (e.g., OTR or TLS) has finished all the handshaking and a high security instant messaging session based on the cryptographic protocol has been established. In one embodiment, the high security connection is ready when line 150 described in FIG. 1 above has been reached.

If the high security connection is ready, process 300 sends (at block 335) the new message to the remote user through the high security connection. Process 300 then loops back to block 320 to check if a new message request has been received from the local user.

If the high security connection is not ready yet, process 300 sends (at block 330) the new message to the remote user through the low security connection. In one embodiment, the new message is sent as low security message 120, as described in FIG. 1 above. Process 300 then loops back to block 320 to check if a new message request has been received from the local user. Process 300 is terminated when the secure instant messaging session is terminated (e.g., by user) or expired (e.g., a certain time limit has passed without user activity or network connection).

One of ordinary skill in the art will recognize that process 300 is a conceptual representation of the operations used to enable a target user to participate in a secure instant messaging session. The specific operations of process 300 may not be performed in the exact order shown and described. For example and in one embodiment, operations in block 315 can be performed before or concurrently with operations in blocks 305 and 310. The specific operations may not be performed in one continuous series of operations, and different specific operations may be performed in different embodiments. Furthermore, process 300 could be implemented using several sub-processes, or as part of a larger macro process. One of ordinary skill in the art will also recognize that a local user and a remote user are two users who use two different devices, and can be physically near each other.

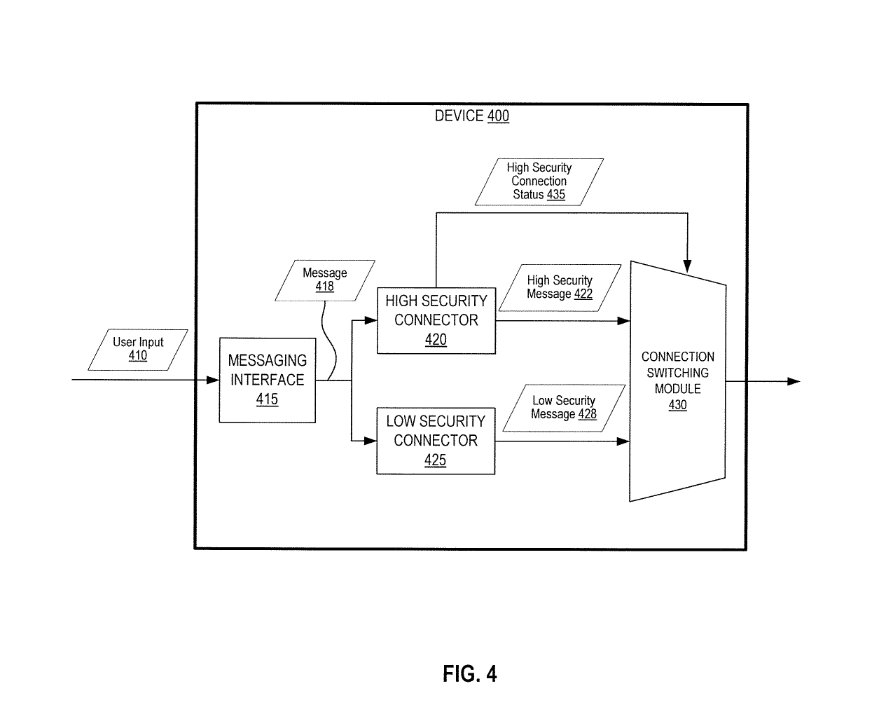

FIG. 4 illustrates a detailed diagram of a device 400 of one embodiment that enables a user to participate in a secure instant messaging session. Specifically, this figure illustrates a set of modules for switching between a high security connection and a low security connection when sending messages during the secure instant message session. The device 400 can be a desktop computer, server, smartphone, laptop, personal digital assistant, music playing device, gaming device, or any other device that can execute instant messaging programs. In one embodiment, the device 400 can be used by the initiating user and/or the target user of the instant messaging session, such as Alice and Bob of FIG. 1. As shown in FIG. 4, the device 400 includes a messaging interface 415, a high security connector 420, a low security connector 425, and a connection switching module 430.

The messaging interface 415 receives user input 410 from a local user who uses the device 400 for instant messaging. In one embodiment, the user input 410 includes text and/or multimedia objects that the local user wants to send to a remote user. Once the local user indicates that a message is ready to be sent, e.g. by selecting a Send or Enter button, the messaging interface 415 organizes the user input 410 into a message 418.

The high security connector 420 establishes a high security connection with a remote user. In one embodiment, the high security connector 420 establishes the high security connection by performing part of the operations described in blocks 208 and 210 of FIG. 2 above. In another embodiment, the high security connector 420 establishes the high security connection by performing part of the operations described in blocks 310 and 315 of FIG. 3 above. The high security connector 420 sends a high security connection status signal 435 to the connection switching module 430 to indicate whether or not the high security connection is ready. Once the high security connection is established, the high security connector 420 converts the message 418 received from the messaging interface 415 into a high security message 422. In one embodiment, the high security message 135 described in FIG. 1 above is a high security message 422 generated by the high security connector 420.

The low security connector 425 establishes a low security connection with the remote user while the high security connector 420 is establishes the high security connection. In one embodiment, the low security connector 425 and the high security connector 420 start establishing connections at the same time, but the low security connector 425 finishes establishing the low security connection first. Before the high security connector establishes the high security connection, the low security connector 425 converts the message 418 received from the messaging interface 415 into a low security message 428. In one embodiment, the low security message 105 described in FIG. 1 above is a low security message 428 generated by the low security connector 425. In another embodiment, the low security message 120 described in FIG. 1 above is a low security message 428 generated by the low security connector 425.

The connection switching module 430 receives the high security connection status signal 435 from the high security connector 420 and determines whether the high security connection is ready based on that signal. If the high security connection is not yet ready, the connection switching module 430 selects the low security message 428 generated by the low security connector 425 to send to the remote user. If the high security connection is ready, the connection switching module 430 selects the high security message 422 generated by the high security connector 420 to send to the remote user. In one embodiment, the connection switching module 430 performs the operations described in blocks 220-230 of FIG. 2 above. In another embodiment, the connection switching module 430 performs the operations described in blocks 325-335 of FIG. 2 above.

The device 400 was described above for one embodiment of the disclosure. One of ordinary skill in the art will realize that in other embodiments, this module can be implemented differently. For instance, in one embodiment described above, certain modules are implemented as software modules. However, in another embodiment, some or all of the modules might be implemented by hardware, which can be dedicated application specific hardware (e.g., an ASIC chip or component) or a general purpose chip (e.g., a microprocessor or FPGA).

Embodiments described in FIGS. 1-4 above generally relate to participating in a secure instant messaging session by switching between a low security connection and a high security connection. One of ordinary skill in the art will recognize that the number of connections being established simultaneously may not be limited to two and there may be other reasons (besides security) for switching from one channel to another channel.

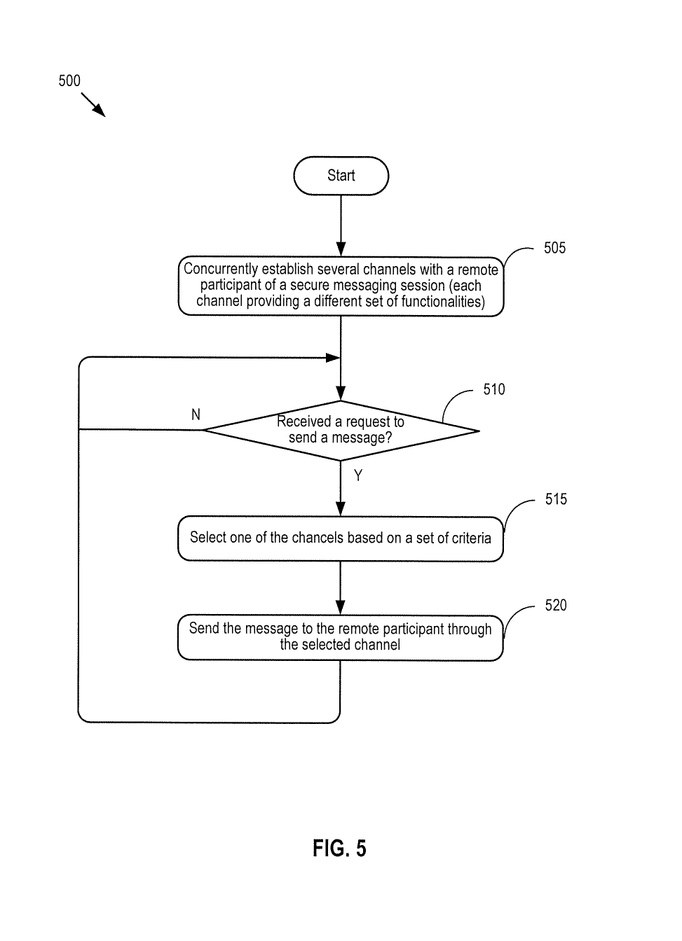

FIG. 5 illustrates a flowchart of one embodiment of a process 500 to participate in a secure instant messaging session by simultaneously negotiating several different types of secure instant messaging channels on a device. In one embodiment, each secure instant messaging channel being negotiated provides a different set of functionality, which may include security related functionalities or non-security related functionalities. In one embodiment, when Alice tries to start a secure instant messaging conversation with Bob as described in relation to FIG. 1 above, or when an old session between them has expired and a new session needs to be initiated, process 500 can be started on one or both ends of the conversation.

Process 500 begins by currently establishing (at block 505) several secure instant messaging channels with a remote participant of the secure instant messaging session. In one embodiment, the local participant is Alice and the remote participant is Bob, as described in relation to FIG. 1 above. In another embodiment, the local participant is Bob and the remote participant is Alice. In one embodiment, different channels have different levels of security by using different cryptographic protocols. In one embodiment, instead of or in conjunction with different levels of security, different channels have different non-security related functionalities.

At block 510, process 500 determines whether a request to send a new message to the remote participant has been received from the local participant. If a request to send a new message has not been received, process 500 loops back to block 510 to check again. If a request to send a new message has been received from the local participant, process 500 selects (at block 515) one channel from the several channels based on a set of criteria.

In one embodiment, the set of criteria ensure the optimal channel (e.g., the channel that has the best usability or the channel has the highest security level) is selected. In one embodiment, the set of criteria includes whether a channel has been established, i.e. whether the negotiation for the channel has been completed. Only a channel that has been established can be selected to send the new message. For example, when the high security connection has not been established, the low security connection is selected to send messages because it can be established without any negotiation, as described in FIGS. 1-4 above.

In one embodiment, the set of criteria includes whether the set of functionalities of a channel include one or more security related functionalities, e.g. perfect forward secrecy and malleable encryption. In one embodiment, the set of criteria includes whether the set of functionalities of a channel include one or more non-security related functionalities. In one embodiment, channels that satisfy these criteria, e.g. include the desired functionalities, can be selected to send the new message. In one embodiment, the set of criteria includes whether a channel has the highest level of security. For example, when the high security connection has been established, the high security connection is selected to send messages because it provides the highest level of security, as described in FIGS. 1-4 above.

At block 520, process 500 sends the new message to the remote participant through the selected channel. Process 500 then loops back to block 510 to check if a new message request has been received from the local participant. Process 500 is terminated when the secure instant messaging session is terminated (e.g., by user) or expired (e.g., a certain time limit has passed without user activity or network connection).

One of ordinary skill in the art will recognize that process 500 is a conceptual representation of the operations used to participate in a secure instant messaging session. The specific operations of process 500 may not be performed in the exact order shown and described. The specific operations may not be performed in one continuous series of operations, and different specific operations may be performed in different embodiments. Furthermore, process 500 could be implemented using several sub-processes, or as part of a larger macro process. One of ordinary skill in the art will also recognize that a local participant and a remote participant are two participants who use two different devices, and can be physically near each other.

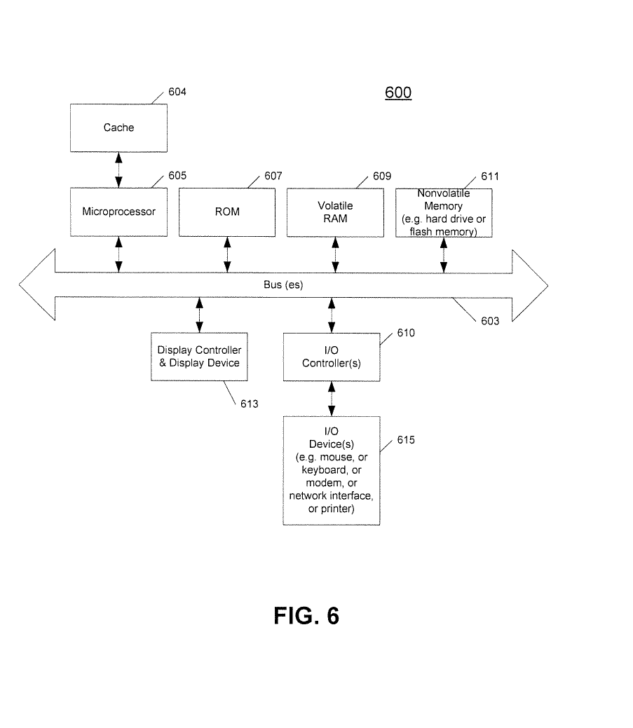

FIG. 6 shows one example of a data processing system 600, which may be used with one embodiment. For example, the system 600 may be implemented including a device 100 as shown in FIG. 1. Note that while FIG. 6 illustrates various components of a device, it is not intended to represent any particular architecture or manner of interconnecting the components as such details are not germane to the disclosure. It will also be appreciated that network computers and other data processing systems or other consumer electronic devices, which have fewer components or perhaps more components, may also be used with embodiments of the disclosure.

As shown in FIG. 6, the device 600, which is a form of a data processing system, includes a bus 603 which is coupled to a microprocessor(s) 605 and a ROM (Read Only Memory) 607 and volatile RAM 609 and a non-volatile memory 611. The microprocessor 605 may retrieve the instructions from the memories 607, 609, 611 and execute the instructions to perform operations described above. The bus 603 interconnects these various components together and also interconnects these components 605, 607, 609, and 611 to a display controller and display device 613 and to peripheral devices such as input/output (I/O) devices 615 which may be mice, keyboards, modems, network interfaces, printers and other devices which are well known in the art. Typically, the input/output devices 615 are coupled to the system through input/output controllers 610. The volatile RAM (Random Access Memory) 609 is typically implemented as dynamic RAM (DRAM), which requires power continually in order to refresh or maintain the data in the memory.

The non-volatile memory 611 is typically a magnetic hard drive or a magnetic optical drive or an optical drive or a DVD RAM or a flash memory or other types of memory systems, which maintain data (e.g., large amounts of data) even after power is removed from the system. Typically, the non-volatile memory 611 will also be a random access memory although this is not required. While FIG. 6 shows that the non-volatile memory 611 is a local device coupled directly to the rest of the components in the data processing system, it will be appreciated that embodiments of the disclosure may utilize a non-volatile memory which is remote from the system, such as a network storage device which is coupled to the data processing system through a network interface such as a modem, an Ethernet interface or a wireless network. The bus 603 may include one or more buses connected to each other through various bridges, controllers and/or adapters as is well known in the art.

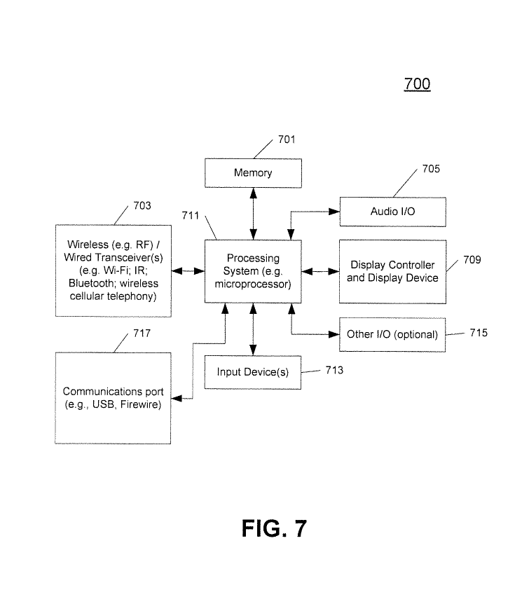

FIG. 7 shows an example of another data processing system 700 which may be used with one embodiment. For example, system 700 may be implemented as a device 100 as shown in FIG. 1. The data processing system 700 shown in FIG. 7 includes a processing system 711, which may be one or more microprocessors, or which may be a system on a chip integrated circuit, and the system also includes memory 701 for storing data and programs for execution by the processing system. The system 700 also includes an audio input/output subsystem 705, which may include a microphone and a speaker, for example, for playing back music or providing telephone functionality through the speaker and microphone.

A display controller and display device 709 provide a visual user interface for the user; this digital interface may include a graphical user interface which is similar to that shown on a Macintosh computer when running OS X operating system software, or Apple iPhone when running the iOS operating system, etc. The system 700 also includes one or more wireless transceivers 703 to communicate with another data processing system, such as the system 700 of FIG. 7. A wireless transceiver may be a WLAN transceiver, an infrared transceiver, a Bluetooth transceiver, and/or a wireless cellular telephony transceiver. It will be appreciated that additional components, not shown, may also be part of the system 700 in certain embodiments, and in certain embodiments fewer components than shown in FIG. 7 may also be used in a data processing system. The system 700 further includes one or more communication ports 717 to communicate with another data processing system, such as the system in FIG. 6. The communication port may be a USB port, Firewire port, Bluetooth interface, etc.

The data processing system 700 also includes one or more input devices 713, which are provided to allow a user to provide input to the system. These input devices may be a keypad or a keyboard or a touch panel or a multi touch panel. The data processing system 700 also includes an optional input/output device 715 which may be a connector for a dock. It will be appreciated that one or more buses, not shown, may be used to interconnect the various components as is well known in the art. The data processing system shown in FIG. 7 may be a handheld device or a personal digital assistant (PDA), or a cellular telephone with PDA like functionality, or a handheld device which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 700 may be a network computer or an embedded processing device within another device, or other types of data processing systems, which have fewer components or perhaps more components than that shown in FIG. 7.

At least certain embodiments of the disclosure may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in U.S. Pat. No. 7,345,671 and U.S. Pat. No. 7,627,343, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The disclosure also relates to an apparatus for performing the operations described herein. This apparatus may be specially constructed for the required purpose, or it may comprise a general-purpose device selectively activated or reconfigured by a computer program stored in the device. Such a computer program may be stored in a computer readable storage medium, such as, but not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a device bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a device memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “sending,” “establishing,” “selecting,” “participating,” or the like, refer to the action and processes of a device, or similar electronic computing device, that manipulates and transforms data represented as physical (electronic) quantities within the device's registers and memories into other data similarly represented as physical quantities within the device memories or registers or other such information storage, transmission or display devices.

The processes and displays presented herein are not inherently related to any particular device or other apparatus. Various general-purpose systems may be used with programs in accordance with the teachings herein, or it may prove convenient to construct a more specialized apparatus to perform the operations described. The required structure for a variety of these systems will be evident from the description below. In addition, the disclosure is not described with reference to any particular programming language. It will be appreciated that a variety of programming languages may be used to implement the teachings of the disclosure as described herein.

The foregoing discussion merely describes some exemplary embodiments of the disclosure. One skilled in the art will readily recognize from such discussion, the accompanying drawings and the claims that various modifications can be made without departing from the spirit and scope of the disclosure.

What is claimed is:

1. A computer-implemented method for participating in a secure instant messaging session at a data processing system, the method comprising:
concurrently establishing a low security connection and a high security connection with a remote participant of the secure instant messaging session;
sending a first message to the remote participant through the low security connection while the high security connection is being established;
determining whether the high security connection is established; and
sending a second message to the remote participant through the high security connection when the high security connection is established.

2. The method of claim 1 further comprising sending the second message to the remote participant through the low security connection when the high security connection is not yet established.

3. The method of claim 1, wherein the first and second messages are received from a local participant of the secure instant messaging session using the data processing system.

4. The method of claim 1, wherein the high security connection uses Off-the-Record Messaging (OTR) protocol or Transport Layer Security (TLS) protocol.

5. The method of claim 4, wherein the low security connection uses a cryptographic protocol that does not provide perfect forward secrecy or malleable encryption.

6. The method of claim 1, wherein the high security connection uses a cryptographic protocol that provides at least one of perfect forward secrecy or malleable encryption.

7. A computer-implemented method for participating in a secure instant messaging session at a data processing system, the method comprising:
receiving requests from a remote participant of the secure instant messaging session to establish a high security connection and a low security connection;
concurrently establishing the high security connection and the low security connection with the remote participant;
receiving a first message from the remote participant through the low security connection while the high security connection is being established;
determining whether the high security connection is established; and
sending a second message to the remote participant through the high security connection when the high security connection is established.

8. The method of claim 7 further comprising sending the second message to the remote participant through the low security connection when the high security connection is not yet established.

9. The method of claim 7, wherein the first and second messages are received from a local participant of the secure instant messaging session using the data processing system.

10. The method of claim 7, wherein the high security connection uses Off-the-Record Messaging (OTR) protocol or Transport Layer Security (TLS) protocol.

11. The method of claim 10, wherein the low security connection uses a cryptographic protocol that does not provide perfect forward secrecy or malleable encryption.

12. The method of claim 7, wherein the high security connection uses a cryptographic protocol that provides at least one of perfect forward secrecy or malleable encryption.

13. A computer-implemented method for participating in a secure instant messaging session at a data processing system, the method comprising:
concurrently establishing a plurality of channels with a remote participant of the secure instant messaging session, wherein each channel provides a different set of functionalities;
selecting one of the plurality of channels based on a set of criteria; and
sending a message to the remote participant through the selected channel.

14. The method of claim 13, wherein the set of criteria comprises whether a channel has been established, wherein a channel has been established when negotiation for the channel has been completed.

15. The method of claim 14, wherein the set of criteria comprises whether the set of functionalities of a channel provides the highest security.

16. The method of claim 14, wherein the set of criteria comprises whether the set of functionalities of a channel comprises at least one of perfect forward secrecy or malleable encryption.

17. The method of claim 14, wherein the set of criteria comprises whether the set of functionalities of a channel comprises a non-security related functionality.

18. A device for participating in a secure instant messaging session, the device comprising:
a processing system;
a memory coupled to the processing system though a bus; and
a process executed from the memory by the processing system that causes the processing system to concurrently establish a plurality of channels with a remote participant of the secure instant messaging session, wherein each channel provides a different set of functionalities, select one of the plurality of channels based on a set of criteria, and send a message to the remote participant through the selected channel.

19. The device of claim 18, wherein the set of criteria comprises whether a channel has been established, wherein a channel has been established when negotiation for the channel has been completed.

20. The device of claim 19, wherein the set of criteria comprises whether the set of functionalities of a channel provides the highest security.
